(19) United States
(12) Patent Application Publication
(10) Pub. No.: US 2026/0304411 A1
(43) Pub. Date: Oct. 1, 2026

(54) Selecting an Active Bandwidth Part using a Machine-Learning Model

(71) Applicant: Telefonaktiebolaget LM Ericsson (publ), Stockholm (SE)

(72) Inventors: Rerngvit Yanggratoke, Järfälla (SE); Kittipong Kittichokechai, Järfälla (SE)

(21) Appl. No.: 19/484,261

(22) PCT Filed: May 15, 2023
(86) PCT No.: PCT/IB2023/054989

§ 371 Date: Nov. 13, 2025

(51) Int. Cl. H04W 72/0457; H04W 24/02; H04W 28/02; H04W 52/36; H04W 72/02

(52) U.S. Cl. CPC H04W 72/0457; H04W 24/02; H04W 28/0278; H04W 52/365; H04W 72/02

(57) ABSTRACT

Methods for selecting an active bandwidth part (BWP) and for configuring a set of BWPs for a user equipment (UE) in a wireless network supporting configurable BWPs. An example method comprises estimating (720) a desired bandwidth for the UE, using a trained machine-learning model operating on measurements for the UE, and selecting (730) a preferred active BWP from candidate BWPs, based on the estimated desired bandwidth. Another example method comprises generating or receiving (810) a feedback metric for a selected active BWP for the UE, the feedback metric indicating a distance of a bandwidth for the selected active BWP from an estimated desired bandwidth, and accumulating (820) the feedback metric with other feedback metrics for the UE and/or one or more other UEs. This example method further comprises determining (830) whether to change a set of BWPs configured for the UE, based on the accumulated feedback metrics.

### TECHNICAL FIELD

The present disclosure is related to techniques for selecting an active bandwidth part (BWP), by or for a user equipment (UE) in a network that supports configurable BWPs.

### BACKGROUND

For the 5th-generation wireless network technology widely known as New Radio or “NR,” as developed by members of the 3rd-Generation Partnership Project (3GPP), the concept of bandwidth part (BWP) was introduced, to support UEs not capable of a full carrier bandwidth, as well as for providing bandwidth adaptation. (See Refs. 1 and 2.) A BWP is basically a contiguous subset of the total carrier bandwidth. For each serving cell, up to four downlink (DL) BWPs can be configured for receptions by the UE. If the serving cell is configured with an uplink (UL), up to four UL BWPs also can be configured for transmissions by the LIE. This is different than in 4th-generation Long-Term Evolution (LTE), which requires a UE to operate with the full carrier bandwidth, as shown in FIG. 1.

As specified by the current specifications for NR, only one DL BWP and one UL BWP can be active at a given time, i.e., selected for active use by the UE. In other words, a UE cannot operate in more than one DL or UL BWPs simultaneously. The UE is also not expected to receive or transmit data outside the active BWP. The UE can be configured with multiple BWPs, which might have different bandwidths, but only one is active at a time for each of the UL and DL. The network can change the active BWP for either and/or both of the UL and DL by sending a Medium Access Control Control Element (MAC CE), or with dedicated signaling, or using downlink control information (DCI) sent over the Physical Downlink Control Channel (PDCCH). A switch in the active BWP can also be triggered by expiration of a bandwidth-part inactivity timer.

A continuing challenge, however, is that bandwidth requirements for a UE do change over time, e.g., browsing a simple page and then watching a 4K video. Selecting the wrong BWP has an efficiency problem for a UE. For example, selecting a too small BWP results in degraded performance, e.g., in terms of achievable data rate, while selecting a too large BWP results in unnecessary excess power consumption of a UE.

Reference 3 presents a method for selecting bandwidth part for random access procedure with the best DL channel quality. Reference 4 discusses a method for optimizing bandwidth part selection for massive beam forming to maintain cell capacity and performance. The method applies the multiple signal classification (MUSIC) algorithm on the Direction of Arrival (DOA) measurements from a UE to first create a signal power profile and then estimate SNR and channel correlation for each UE. The method then decides whether UEs should belong to the same beam forming group (similar bandwidth part) according to the thresholds of SNR and channel correlation.

Reference 5 presents a performance simulation study when UEs perform dynamic switching of BWPs using presence of DL traffic and BWP inactivity timer. Reference 6 discloses static BWP selections, e.g., based on preconfigured rules like using a different BWP in Radio Resource Control (RRC) idle state, as compared to in RRC connected state.

Despite these references, further improvements in BWP selection are needed.

### SUMMARY

The techniques, apparatuses, and systems described herein address the problem of selecting, e.g., at the base station, which active DL/UL BWP for a UE should be active. Some of the techniques, apparatuses, and systems further involve reconfiguring the set of BWPs for a UE. For a given configured set of bandwidth parts of a UE for a carrier and a UE, the techniques disclosed herein can be used to recommend a particular DL/UL BWP to be active. FIG. 2 presents an overview of the problem definition, for a scenario where a UE is configured with at least two BWPs. As seen in the figure, the active BWP may change from one time to another. The difficulty is determining which BWP should be active at a given time, and changing the active BWP as needed to optimize performance.

One key use case of the techniques described herein is eXtended Reality (XR), where there are service requirements related to minimum data rate, reliability, and bounded latency, and at the same time, there is a need for UE to operate in a most energy efficient manner. Selecting an appropriate active BWP for fulfilling these requirements is thus very important.

Embodiments of the techniques, apparatuses, and systems described herein include a method for selecting a preferred active BWP for a UE in a wireless network supporting configurable BWPs. This method comprises estimating a desired bandwidth for the UE, using a trained machine-learning model operating on a plurality of measurements for the UE. The method further comprises selecting a preferred active BWP from a plurality of candidate BWPs, based on the estimated desired bandwidth. Although a radio network node (e.g., an NR base station) may have access to more processing resources for running the machine-learning model and applying it to a current scenario, this example method might be implemented in the UE, in which case it could signal the selected preferred active BWP to the network, or by a radio network node or other network node, in various embodiments. The measurements used by the machine-learning model may include such things as buffer status reports (BSRs), power headroom reports (PHRs), uplink and/or downlink data rates, and/or uplink and/or downlink physical resource block (PRB) utilization, for example. Service requirement inputs, such as minimum data rate, might also be used. In addition, assistance information such as UE preferences, or a number of supported multiple-input multiple-output (MIMO) layers might be used as well, or instead.

Another example method, according to some embodiments, comprises generating or receiving a feedback metric for a selected active BWP for the UE, the feedback metric indicating a distance of a bandwidth for the selected active BWP from an estimated desired bandwidth, and accumulating the feedback metric with other feedback metrics for the UE and/or one or more other UEs. This example method further comprises determining whether to change a set of BWPs configured for the UE, based on the accumulated feedback metrics.

Apparatuses and systems configured to carry out these and related methods are also described in detail in the description that follows, and illustrated in the attached figures.

### BRIEF DESCRIPTION OF THE DRAWINGS

FIG. 1 shows the use of bandwidth parts (BWPs) in NR, as compared to LTE.

FIG. 2 illustrates a problem with BWP selection.

FIG. 3 shows the use of a trained machine-learning model for predicting future bandwidth requirements of a UE.

FIG. 4 is a process flow diagram illustrating an overview of methods for selecting a preferred active BWP and for configuring a set of BWPs, according to some embodiments.

FIG. 5 illustrates the logical architecture of the O-RAN, and its control loops.

FIG. 6 shows the Near-RT RIC internal architecture, according to some embodiments.

FIG. 7 is a process flow diagram illustrating an example method, according to some embodiments.

FIG. 8 is a process flow diagram illustrating another example method, according to some embodiments.

FIG. 9 illustrates a block diagram of a network node, according to some embodiments.

FIG. 10 illustrates a block diagram of a wireless device, according to some embodiments.

FIG. 11 schematically illustrates a telecommunication network connected via an intermediate network to a host computer, according to some embodiments.

FIG. 12 is a generalized block diagram of a host computer communicating via a base station with a user equipment over a partially wireless connection, according to some embodiments.

FIGS. 13 to 16 are flowcharts illustrating example methods implemented in a communication system including a host computer, a base station and a user equipment.

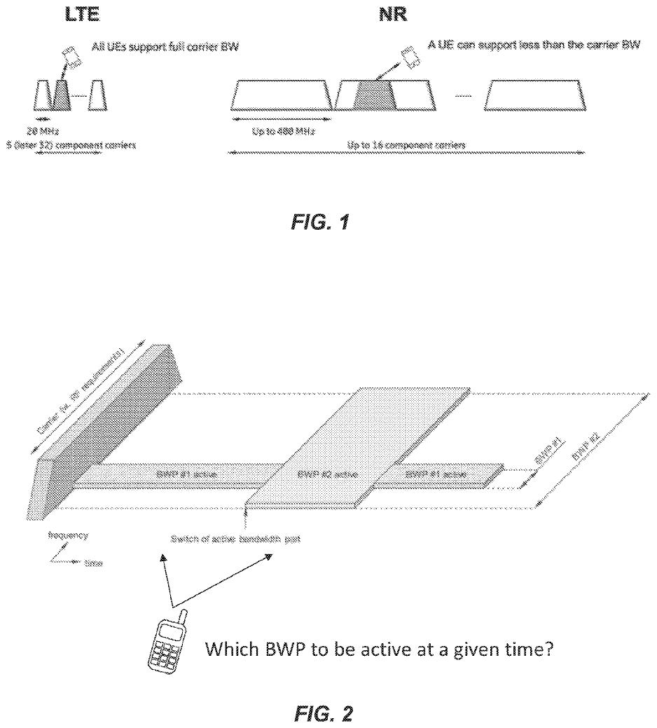

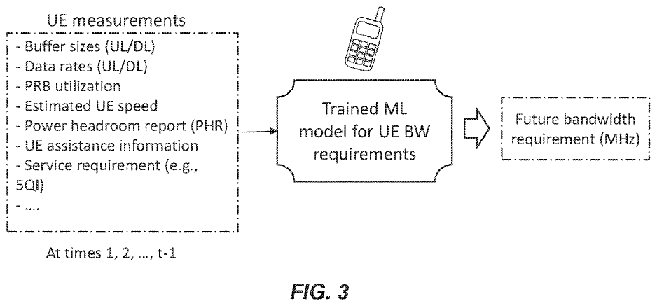

### DETAILED DESCRIPTION

Exemplary embodiments of the present disclosure will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment can be tacitly assumed to be present/used in another embodiment.

As noted above, further improvements in BWP selection are needed. A problem with Reference 3, for example, which describes a BWP selection process for use in a random access procedure, based on the best DL channel quality, is that it assumes that UE can have multiple active BWPs in both UL and DL. Such an assumption is not applicable in the current NR standard since only one active BWP is feasible at a given time. Furthermore, the method is only applicable to random-access procedure rather than general UL/DL transmission. The approach described in Reference 4 mainly focuses on channel capacity (in other words, spectrum efficiency) in the context of massive beam forming, but does not consider reduced energy consumption of UEs, which is also very important. Reference 5 describes a simple mechanism to trigger the BWP switching of a UE, i.e., the presence of DL traffic and a BWP inactivity timer. However, such a mechanism is static and does not adapt to a realistic scenario in which UE bandwidth requirements do change over time. Likewise, the static selections described in Reference 6 cannot handle dynamic and time-varying bandwidth requirements of UEs. For instance, even in the same RRC connected state, if a UE is watching a streaming video, its bandwidth requirement would be different than when a UE would be opening a static website. Such a dynamic scenario cannot be captured with the static BWP selections disclosed in prior art.

The techniques described herein include an automated method to recommend an active bandwidth part for a UE, using machine learning. Example methods detailed below apply a trained machine-learning model to forecast future UE bandwidth requirements based on past and current measurements. These forecasted UE bandwidth requirements may be used in turn to select an active BWP for the UE. The methods described herein are data-driven and allow for dynamic adaptation of UE bandwidth requirements that generally change over time.

Embodiments of the presently disclosed techniques use a data-driven approach (machine learning) to perform the recommendation of an active BWP for each individual UE. This recommendation can be used either at the UE side, to request a certain BWP from the network, or at the base station side, to support making a scheduling decision, or both. Signaling between a UE and a base station (e.g., a gNB) is also described herein, e.g., to address receiving a request to assess active bandwidth part and/or recommend switching active bandwidth part for a UE.

FIG. 3 illustrates the use of a trained machine-learning model to estimate bandwidth requirements, or desired bandwidth, according to some of the techniques described herein. As will be discussed in further detail below, inputs to the trained machine-learning model may include such things as UL and/or DL buffer sizes, data rates, physical resource block (PRB) utilization, the UE's speed, power headroom reports (PHRs), etc. Other inputs might include UE assistance information, e.g., UE preferences or capabilities, as well as service requirements, such as minimum data rates, reliability requirements, etc. These inputs are provided to a machine-learning model that has been trained using similar inputs associated with “correct” determinations of UE bandwidth requirements, to estimate a future bandwidth requirement for a UE, or group of UEs for a given time instance t, where the inputs are for each of one or more previous time instances 1, 2, . . . , t−1. Note that the terms “bandwidth requirement” and “desired bandwidth” may be used interchangeably when referring to a prospective need. The future bandwidth requirement estimated by the machine-learning models described herein may thus be understood as estimating a “desired bandwidth.” where this is a bandwidth that suits the UE's needs best, at a given time, for a given link (uplink or downlink).

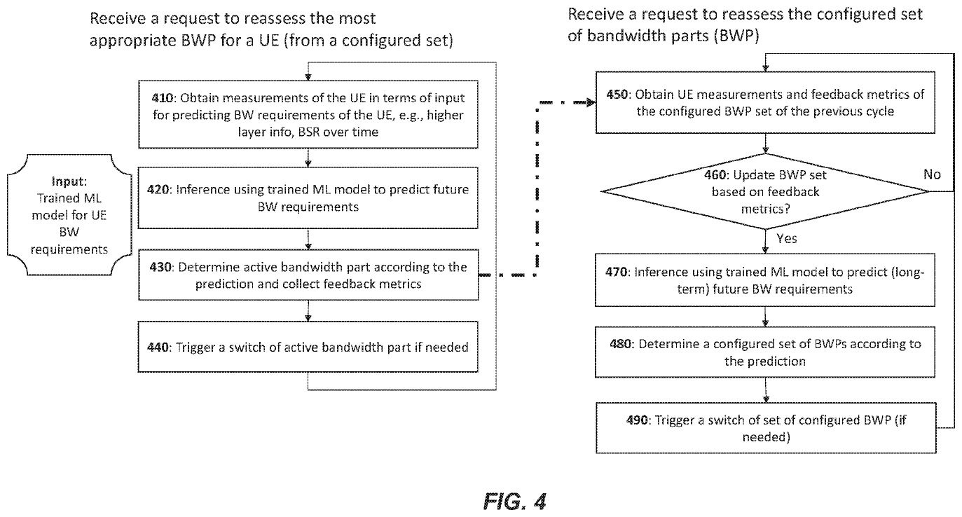

FIG. 4 illustrates an overview of several methods presented in this invention. It essentially is a control loop for continuously optimizing the BWP selection of a UE in terms of matching it with bandwidth requirements for the UE. This method is for executing in an apparatus that is in or connected to a base station, for example.

An input to this method is a machine-learning model that has been trained, using recorded data and coded bandwidth requirements for UEs, to predict bandwidth requirements. The method's execution is triggered by a request to reassess the most appropriate BWP for a UE. Such a request might be periodic (e.g., every X seconds or minutes) or event-driven (e.g., request by a network optimization program or even by a UE). Following the trigger, the illustrated method comprises several major steps.

First, as illustrated on the left-hand side, is a control loop for selecting an active BWP from currently configured BWPs for the UE. As shown at block 410, this process begins with obtaining measurements of the UE in terms of input for predicting BW requirements of the UE. These measurements may be various parameters or metrics associated with the UE and related to traffic throughput, for example, in either the uplink direction, the downlink direction or both. The measurements may be gathered from higher layer information, BSRs reported over time, etc., and used as inputs to the trained ML to predict future UE BW requirements. Inputs to the model may include other information as well as the UE measurements. The inputs might include any of the following, for example:
(History of) buffer status report (BSR) from the UE, indicating the data size in the UE UL buffer
Service requirements in terms of minimum data rate, reliability, and latency
UE assistance information, indicating power saving preference such as preferred maximum BW, number of MIMO layers, etc.
UE power headroom report, indicating the headroom between the current estimated UE transmit power and the maximum UE transmit power

The output of the model is a UE bandwidth requirement, which is a desired bandwidth by a UE according to its current data transfer activity, regardless of BWP selection. In other words, this BW requirement is not the same as measured UE throughput (either UL/DL), since the latter is affected by the selected BWP configured at time of the throughput measurement.

The UE's actual bandwidth requirements at time 1, 2, . . . , t−1 may be calculated from existing UE measurements by the following steps, in some embodiments. For UL, the UE BW requirement can be calculated from BSR and some other parameters such as over-the-air latency and reliability requirements. For DL, the minimum required DL data rate obtained from higher layer, e.g., the application layer as part of the 5QI or service profile for each application type can be used as input for calculating the UE bandwidth requirement.

In general, a minimum UE BW requirement can be computed as

$$minimum required UE BW ( Hz ) = \frac{required data rate ( bits / s )}{spectral efficiency ( bits / s / Hz )}$$

where the spectral efficiency can be derived from reliability requirement and estimated UE channel quality, e.g., a required modulation and coding scheme (MCS) at which a target packet error rate can be achieved at the estimated signal to noise ratio (SNR). The minimum required DL data rate above refers to a minimum amount of data transferred per time unit that is required for the UE to access and utilize the network without performance (or Quality of service QoS) problems. As a result, this depends on current applications and changes over time.

As shown at block 420 in FIG. 4, the method further comprises inference, using the trained ML model, to predict future BW requirements. As noted, prior to the method's execution, the machine learning model has been trained. (Details of the machine learning model and its training are described below.)

In this step, the method feeds in UE measurements obtained in the previous step to the trained ML model. Following that, the trained ML model will output the predicted (or forecasted) future bandwidth requirement of the UE (MHz) at future time t. The predicted bandwidth requirement may be referred to as BW_{pred}(t).

Note that the future time t can be in any of various different granularities, e.g., next Y milliseconds or minutes. Furthermore, the prediction output by the trained ML model is not limited to a single time—it can as well be an array of future times, e.g., [BW_{pred}(t), BW_{pred}(t+1), . . . BW_{pred}(t+n)]. From this point in this document, BW_{pred}(t) is considered for simplicity, as an illustration of the concept.

As shown at block 430, the method may further comprise determining the (preferred) active bandwidth part according to the prediction. At this step, feedback metrics may be collected as well, for use in a distinct set of operations for reassessing the currently configured BWPs for the UE.

In this step, the prediction from the previous step is used to select a bandwidth part to recommend for a UE to be active at time t. This is a selection of BWP for a UE from among configured BWPs for the carrier, e.g., [BWP₁, . . . , BWP₄].

Each BWP will have its own associated bandwidth. Two alternative embodiments are described below, the choice of which may depend on operator preference between spectrum efficiency and UE power consumption.

As an example, to illustrate the concept, if a UE and its carrier in question is configured with four BWPs of sizes 15, 30, 45, and 60 MHz, and the predicted future bandwidth requirement for the UE at time t (BW_{pred}(t)) is 40 MHz, then a selection step might use one of the following approaches:
1. Spectrum efficiency preference: picking the lowest feasible one that is higher than the predicted BW size. In the above example, 45 MHz should be selected.
2. UE power consumption preference: picking the highest feasible one that is lower than the predicted BW size. In the above example, it would mean selecting 30 MHz
3. Selection based on the minimum difference: picking the one among configured BWPs of which the size is closest to the predicted BW size. In the above example, it would mean selecting 45 MHz.

In any of the above methods, the UE preference for the maximum BW of active BWP, e.g., maximum BW preference information carried in the UE assistance information message, can further be taken into account to select the appropriate active BWP.

At this point in the process, a feedback metric related to suitability of the currently configured BWPs might be computed, in some embodiments. In one example, the feedback metric at time t is computed as a “distance” between the predicted required BW, BW_{pred}(t) obtained from the previous step and the selected active BWP obtained in this step, i.e., |BW_{pred}(t)-selected active BWP at time di. This feedback metric information can be collected for every required bandwidth prediction instant and can be used to in a separate control loop for reconfiguring a set of BWPs at the UE, as will be discussed in further detail, below.

As shown at block 440, the method may further comprise the step of triggering a switch of active bandwidth part if needed. If an active BWP recommended by the method (from the previous step) is different than the current active BWP of a UE, an apparatus can send a recommendation signal to a base station, so that the base station can trigger a switch of active bandwidth part for a UE. Alternatively, a base station can trigger a switch of active bandwidth part for the UE. The steps shown in blocks 410-440 can be repeated, e.g., periodically, or upon request, in various embodiments.

FIG. 4 illustrates a second set of operations, on the right-hand side of the figure, which provide a control loop for reconfiguring a set of BWPs. This process is distinct from the process of selecting a preferred active BWP, as shown at blocks 410-440, but may be performed in conjunction with that process. While the first control loop, on the left-hand side of the figure, is used to perform prediction of the bandwidth requirement, the predicted bandwidth requirement at time t, BW_{pred}(t), may not match exactly with any of the configured BWP values. In such case, an extra step can be performed to select an active BWP from a set of configured BWPs for the UE based on some rule, e.g., as discussed above in connection with block 430. Over time, the differences between the values provided by the bandwidth requirement prediction and the actual bandwidths of the selected active BWP indicate the suitability of the current set of configured BWPs at the UE. It may be the case, for example, that a different BWP that better matches frequent requirements of the UE is available to be configured, but has not yet been configured.

Thus, the right-hand side of FIG. 4 shows steps involved in a separate control loop for reconfiguring a set of BWPs at the UE, based on the feedback metrics provided from the left-hand side and relevant UE measurements for predicting future BW requirements.

As shown at block 450, the method includes the step to obtain UE measurements and feedback metrics of the configured BWP set of the previous cycle(s). A similar set of measurements used to predict future UE BW requirements as described above may be used here to predict (long term) future BW requirements of the UE. In addition, the feedback metrics obtained from the control loop shown in blocks 410-450 are used as inputs to decide whether a current set of configured BWPS at the UE should be updated.

As shown at block 460, the method includes a decision as to whether to update a set of BWPs, where this decision is based on feedback metrics. There exist several techniques to decide whether a current set of configured BWPS at the UE should be updated based on the feedback metrics. One example is to decide by comparing a derived metric with a certain threshold, where the derived metric value is computed based on the feedback metric values. If the derived metric value is above the threshold, a current set of BWPs is to be updated and the control loop proceeds to the next steps.

The derived metric value may be computed, for example, as a mean value of the feedback metrics, or as a maximum value of the feedback metrics, or as an X-percentile value of the feedback metrics, where X∈[1, 2, . . . , 99]. The set of feedback metrics used to compute the derived metric value can be limited to those feedback values corresponding to the time duration from the previous update of the configured BWPs to the current update of the configured BWPs.

As shown at block 470, the method comprises inference using trained ML model to predict (long-term) future BW requirements. The main purpose of this step is to predict (long-term) future BW requirements of the UE. To achieve that, a variant of the model presented in FIG. 3 may be used. In this variant, there are two main differences as compared to the model used at block 420, which has implications on data used for training the model. For training the model used for the long-term prediction in block 470, sequence prediction algorithms, e.g., Long short-term memory (LSTMs) networks or transformer-based architecture can be used, in various embodiments. The time scale is longer here, since this control loop for reconfiguration of BWPs would be expected to run less frequently. For example, if the control loop on the left-hand side of FIG. 4 is run on a time scale of minutes, the control loop on the right-hand side of FIG. 4 might be executed at a period of one hour or several hours. In some embodiments, the amount of output variables, i.e., the BW requirement values of the UE, should be plural values. For instance, if the control loop is for an hour, the output can be sixty BW requirement values, representing every minute.

Then, the model inference for this variant is performed using a trained model, using UE measurements obtained earlier as inputs, to obtain (long-term) predictions, e.g., the predicted UE BW requirements in the next hour, e.g., for every minute. Specifically, for example, if the current time is 09.00, there will be 60 predictions for 09.01, 09.02, . . . , 09.58, 09.59, 10.00. These (long-term) predictions will be used in the next step.

As shown at block 480, the method comprises the step of determining a set of BWPs to be configured, based on the UE measurements—more specifically, based on the long-term predictions for bandwidth requirements. In this step, the method uses the (long-term) predictions in the previous step to determine a next set of BWPs to configure for the UEs. This can be done, for example, by applying unsupervised learning algorithm referred to as clustering (or grouping) algorithm.

Concrete examples of such algorithms are K-Mean and K-Shape. Those algorithms require specifically the number of clusters or groups to be specified. In this case, K should be four, because of the limit of 4 BWPs to be configured, which represents the number of clusters or groups to identify. The clustering algorithms will thus produce four clusters (from the input predictions). The method can then use the centroids of those four clusters (which is a representative number) as the new BWPs to configure for the UE.

As shown at block 490, the next step is to trigger a switch of set of configured BWPS, if needed. If a recommended set of BWPs (in the previous step) is different than the current set of configured BWPs of a UE. An apparatus can send a recommendation signal to a base station, so that the base station can trigger a switch of set of configured BWPs for the UE.

The following describes the machine-learning model for predicting UE bandwidth requirements. FIG. 3 illustrates, at a high level, the design of the supervised machine learning model for a UE. The model takes, as input, current and past UE measurements and outputs a prediction of future bandwidth requirement at time t for the UE. Examples of the UE measurements as well as example definitions and calculations of UE bandwidth requirement from such UE measurements are discussed above.

To train the model, many associated pairs between input and output in FIG. 3 are collected in a centralized location. In a following step, concrete machine-learning models that can be used for training include linear regression, neural network, tree-based models like regression trees and random forests. After the training process, the model can be applied as described above.

The model training does not have to be a per-UE model, although it may be, in some embodiments. As another alternative, the model (as well as its training) can be per a group of UEs, e.g., as identified by other properties available in the radio access network, for instance, traffic pattern over time, frequently used cells, UE capabilities, rate of number of resource blocks consumption, etc. This approach means that those UEs can share the trained model within its group for predicting BW requirements. For these embodiments, this also means that an extra step to identify a group to which a UE belongs is required. An example of how this can be done is to use unsupervised learning techniques called clustering. Then, for the case of traffic patterns over time, the UE (with unknown group) first provides its traffic pattern to allow its group to be identified, and then the trained model for that group is used for prediction.

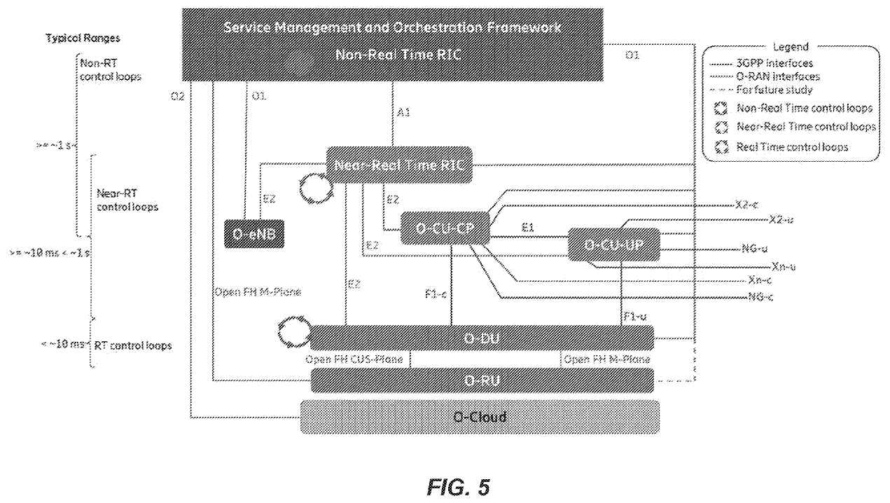

An Open Radio Access Network (O-RAN) is an open standard for next generation radio access networks (RANs), driven mostly by telecom operators. FIG. 5 illustrates the O-RAN architecture and its control loops, which are mainly executed by RAN intelligent controllers (RICs).

The RICs can be broadly categorized into two categories. The Near-real-time RAN intelligent controller (Near-RT RIC) is for automating functions between 10 milliseconds to one second. The Non-real-time RAN intelligent controller (Non-RT RIC) is for automating functions between one second or longer. (See Reference 7.) The role of the Non-RT RIC is to provide high-level control signals to Near-RT RICs via the A1 interface; such signals may include but are not limited to policy-based guidance, ML model management, and enrichment of data.

The role of Near-RT RICs is to perform low-level control signals to O-RAN compatible network elements via the E2 interface. Example applications for the Near-RT-RIC, which are referred to as xApps, are handover decisions, dual connectivity, predicting QoE (quality of experience) of a UE, while example applications for Non-RT-RIC, which are also referred to as rApps, are orchestration, programmability, and optimization.

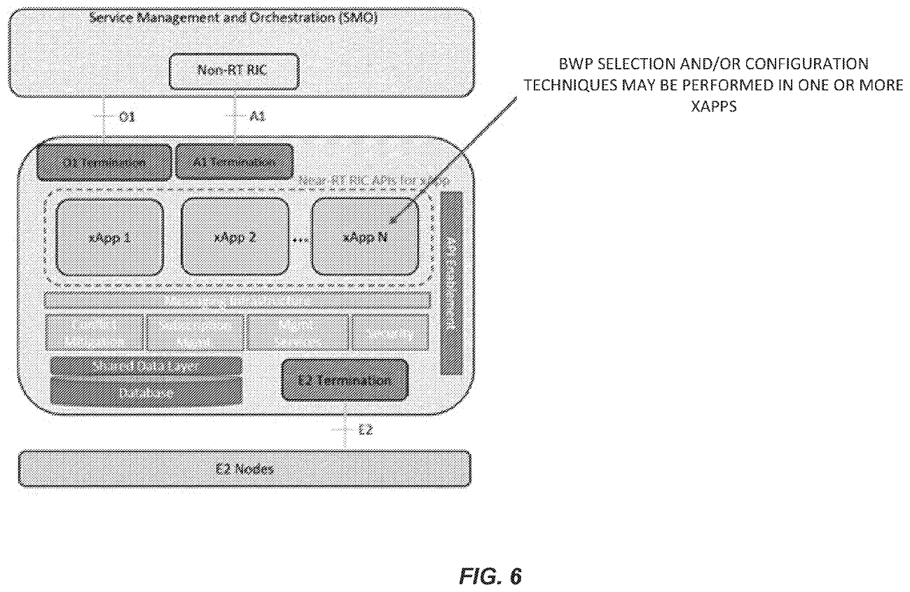

The techniques described herein may be implemented as part of the O-RAN architecture in the form of an xApp. FIG. 6 presents a Near-RT RIC internal architecture and illustrates where the techniques described herein can be realized, in some embodiments, i.e., in the form of one or more xApps. Note that the step for obtaining UE measurements (the first step in FIG. 4, as described above) can be done through the E2 interface illustrated in FIG. 6.

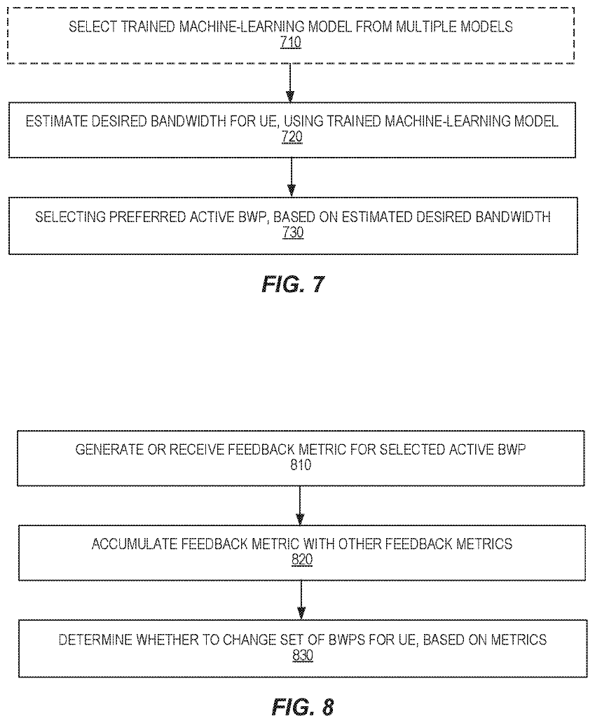

In view of the specific examples and explanation provided above, it will be appreciated that FIG. 7 is a process flow diagram illustrating an example method for selecting a preferred active BWP for a UE in a wireless network supporting configurable BWPs. This method is intended to be a generalization of and to encompass many of the various techniques described above, and thus where there are differences in terminology used below to describe the illustrated method, as compared to the discussion of various examples above, the terminology used below should be interpreted to at least encompass the related terminology used above.

The core of the method of FIG. 7 includes, as shown at block 720, the step of estimating a desired bandwidth for the UE, using a trained machine-learning model operating on a plurality of measurements for the UE. As shown at block 730, the method further comprises selecting a preferred active BWP from a plurality of candidate BWPs, based on the estimated desired bandwidth.

Although a network node (e.g., an NR base station, or gNB) is likely to have more processing resources, the steps shown in blocks 720 and 703 can be carried out by the UE, in some embodiments. In these embodiments, the method may further comprise signaling, to the wireless network, an indication of the selected preferred active BWP. This signaling may be conditioned upon determining that the selected preferred active BWP differs from the currently active BWP. In such embodiments, the method may further comprise receiving, in response to said signaling, an indication to change to the selected preferred active BWP.

Alternatively, the method may be carried out by a node in the wireless network, such as in an NR gNB or other network node or base station. In these embodiments, the method may further comprise signaling, to the UE, an indication to change to the selected preferred active BWP. Again, this signaling may be conditioned upon determining that the selected preferred active BWP differs from the currently active BWP for the UE.

In any of the various embodiments, the plurality of measurements may comprise any one or more of any of, for example: BSRs, PHRs, uplink and/or downlink data rates, and uplink and/or downlink PRB utilization. These might be regarded as throughput-related measurements or parameters, and other such throughput-related parameters might be used as well as, or instead of, these examples.

In some embodiments, the trained machine-learning model may further operate on one or more service requirement inputs for the UE. These one or more service requirement inputs may comprise any one or more of any of the following, for example: a minimum data rate for the UE, a reliability requirement for the UE, and a latency requirement for the UE.

Similarly, in some embodiments, the trained machine-learning model may further operate on one or more assistance inputs for the UE. These one or more assistance inputs may include any one or more of any of the following, for example: a preferred maximum bandwidth for the UE, and a number of MIMO layers.

The selection of the preferred active BWP may use any of a number of rules, or selection strategies. In various embodiments, selecting the preferred active BWP comprises selecting the preferred active BWP according to one of the following selection strategies: selecting a BWP having the lowest bandwidth, among the plurality of candidate BWPs, that is greater than the estimated desired bandwidth; selecting a BWP having the highest bandwidth, among the plurality of candidate BWPs, that is lower than the estimated desired bandwidth; and selecting a BWP having bandwidth closest to the estimated desired bandwidth, among the plurality of candidate BWPs. Other strategies are possible.

In some embodiments, the trained machine-learning model has been trained using measurements for each of a plurality of UEs. In some embodiments, there may be multiple models available for use, where each model is trained with data corresponding to distinct groups of UEs or UE-types. Thus, in some embodiments, the method may comprise selecting the trained machine-learning model from a plurality of trained machine-learning models, according to a characteristic or classification of the UE, where the selected trained machine-learning model has been trained using throughput-related measurements for a respective plurality of UEs having the same or similar characteristic or classification. This is shown at block 710 in FIG. 7, which is illustrated with a dashed outline to indicate that it need not appear in all embodiments or instances of the method. As discussed above, the classification may be according to traffic type or pattern, for instance.

The method shown in FIG. 7 generally corresponds to the control loop illustrated in the left-hand side of FIG. 4. FIG. 8 is a process flow diagram illustrating a method for configuring active BWPs in a wireless network supporting configurable BWPs, corresponding generally to the control loop shown in the right-hand side of FIG. 4. It will be appreciated that the method shown in FIG. 8 may be implemented or carried out in conjunction with the method shown in FIG. 7, in some embodiments. Once again, this method is intended to be a generalization of and to encompass many of the related techniques described above, and thus where there are differences in terminology used below to describe the illustrated method, as compared to the discussion of various examples above, the terminology used below should be interpreted to at least encompass the related terminology used above.

As shown at block 810, the illustrated method includes the step of generating or receiving a feedback metric for a selected active BWP for the UE, the feedback metric being indicative of a distance of a bandwidth for the selected active BWP from an estimated desired bandwidth. The method further comprises accumulating the feedback metric with a plurality of feedback metrics for the UE and/or one or more other UEs, as shown at block 820. The method still further comprises, as shown at block 830, determining whether to change a set of BWPs configured for the UE, based on the accumulated feedback metrics. This may be a change in one or several of the BWPs configured for the UE, or the addition of a configured BWP, in the event that the UE is configured with fewer than the maximum number.

In the event that it is determined that the set of BWPs should be changed, the method may further comprise signaling, to the UE, an indication of a change in BWP configuration for the UE. This applies when the method is carried out by a network node, such as a base station. If the method is carried out by the UE, the method may instead comprise signaling, to the wireless network, an indication of a desired change in BWP configuration for the UE, when the determining step shown in block 830 results in a determination that the set of configured BWPs should change.

As noted above, the method shown in FIG. 8 may be implemented and/or carried out in conjunction with the method shown in FIG. 7. This means, for example, that after the set of configured BWPs is changed, the procedure shown in FIG. 7 may be carried out with respect to the changed set of BWPs, which may include more optimal choices for BWP for the UE in the future. All the variations described above, e.g., with respect to the trained machine-learning model, etc., are applicable in this scenario.

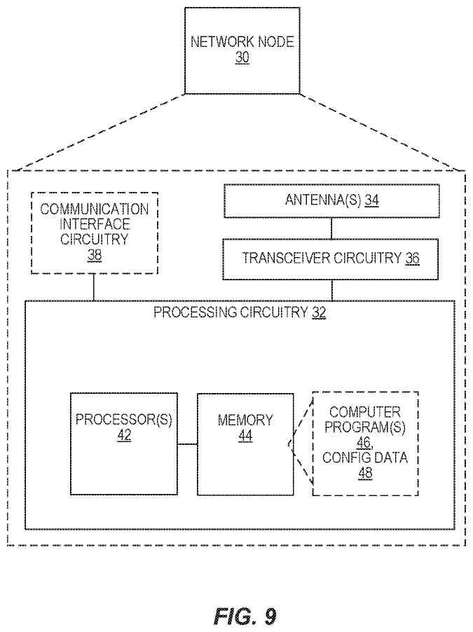

FIG. 9 shows a network node 30, such as a base station, which may be configured to carry out one or more of these disclosed techniques. The base station may be an evolved Node B (eNodeB), Node B or gNB, for example. These operations can be performed by other kinds of network nodes or relay nodes. In the non-limiting embodiments described below, the network node 30 will be described as being configured to operate as a cellular network access node in an LTE network or NR network.

Those skilled in the art will readily appreciate how each type of node may be adapted to carry out one or more of the methods and signaling processes described herein, e.g., through the modification of and/or addition of appropriate program instructions for execution by processing circuits 32.

The network node 30 facilitates communication between wireless terminals, other network access nodes and/or the core network. The network node 30 may include communication interface circuitry 38 that includes circuitry for communicating with other nodes in the core network, radio nodes, and/or other types of nodes in the network for the purposes of providing data and/or cellular communication services. The network node 30 communicates with wireless devices using antennas 34 and transceiver circuitry 36. The transceiver circuitry 36 may include transmitter circuits, receiver circuits, and associated control circuits that are collectively configured to transmit and receive signals according to a radio access technology, for the purposes of providing cellular communication services.

The network node 30 also includes one or more processing circuits 32 that are operatively associated with the transceiver circuitry 36 and, in some cases, the communication interface circuitry 38. The processing circuitry 32 comprises one or more digital processors 42, e.g., one or more microprocessors, microcontrollers, Digital Signal Processors (DSPs), Field Programmable Gate Arrays (FPGAs), Complex Programmable Logic Devices (CPLDs). Application Specific Integrated Circuits (ASICs), or any mix thereof. More generally, the processing circuitry 32 may comprise fixed circuitry, or programmable circuitry that is specially configured via the execution of program instructions implementing the functionality taught herein, or may comprise some mix of fixed and programmed circuitry. The processor 42 may be multi-core, i.e., having two or more processor cores utilized for enhanced performance, reduced power consumption, and more efficient simultaneous processing of multiple tasks.

The processing circuitry 32 also includes a memory 44. The memory 44, in some embodiments, stores one or more computer programs 46 and, optionally, configuration data 48. The memory 44 provides non-transitory storage for the computer program 46 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, the memory 44 comprises any one or more of SRAM, DRAM, EEPROM, and FLASH memory, which may be in the processing circuitry 32 and/or separate from the processing circuitry 32. The memory 44 may also store any configuration data 48 used by the network access node 30. The processing circuitry 32 may be configured, e.g., through the use of appropriate program code stored in memory 44, to carry out one or more of the methods and/or signaling processes detailed hereinafter.

The processing circuitry 32 of the network node 30 is configured, according to some embodiments, to serve a wireless device configured to selectively operate in one of two or more previously configured BWPs, where each BWP is a different subset of an available bandwidth for uplink and/or downlink operation. The processing circuitry 32 of the network node 30 may be configured to carry out either or both of the methods illustrated in FIGS. 7 and 8, for example.

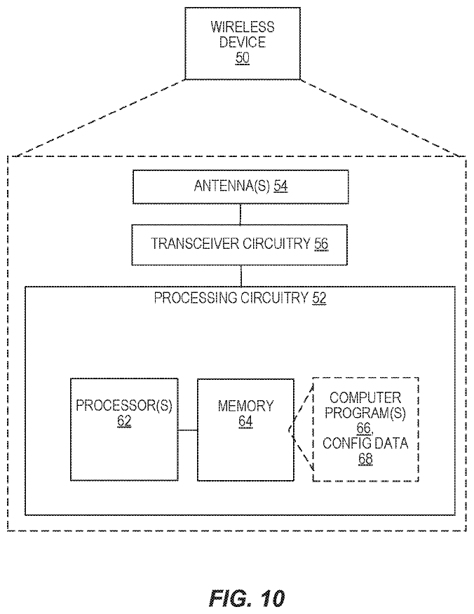

FIG. 10 illustrates a diagram of a wireless device, shown as wireless device 50, according to some embodiments. The wireless device 50 may be considered to represent any wireless terminals that may operate in a network, such as a UE in a cellular network. Other examples may include a communication device, target device, device to device (D2D) UE, machine type UE or UE capable of machine to machine communication (M2M) a sensor equipped with UE, PDA (personal digital assistant), Tablet, mobile terminal, smart phone, laptop embedded equipped (LEE), laptop mounted equipment (LME), USB dongles. Customer Premises Equipment (CPE), etc.

The wireless device 50 is configured to communicate with a radio network node or base station in a wide-area cellular network via antennas 54 and transceiver circuitry 56. The transceiver circuitry 56 may include transmitter circuits, receiver circuits, and associated control circuits that are collectively configured to transmit and receive signals according to a radio access technology, for the purposes of using cellular communication services. This radio access technologies are NR and LTE for the purposes of this discussion.

The wireless device 50 also includes one or more processing circuits 52 that are operatively associated with the radio transceiver circuitry 56. The processing circuitry 52 comprises one or more digital processing circuits, e.g., one or more microprocessors, microcontrollers, DSPs, FPGAs, CPLDs, ASICs, or any mix thereof. More generally, the processing circuitry 52 may comprise fixed circuitry, or programmable circuitry that is specially adapted via the execution of program instructions implementing the functionality taught herein, or may comprise some mix of fixed and programmed circuitry. The processing circuitry 52 may be multi-core.

The processing circuitry 52 also includes a memory 64. The memory 64, in some embodiments, stores one or more computer programs 66 and, optionally, configuration data 68. The memory 64 provides non-transitory storage for the computer program 66 and it may comprise one or more types of computer-readable media, such as disk storage, solid-state memory storage, or any mix thereof. By way of non-limiting example, the memory 64 comprises any one or more of SRAM, DRAM, EEPROM, and FLASH memory, which may be in the processing circuitry 52 and/or separate from processing circuitry 52. The memory 64 may also store any configuration data 68 used by the wireless device 50. The processing circuitry 52 may be configured, e.g., through the use of appropriate program code stored in memory 64, to carry out one or more of the methods and/or signaling processes detailed hereinafter.

The processing circuitry 52 of the wireless device 50 is configured, according to some embodiments, to selectively operate in one of two or more previously configured BWPs, where each BWP is a different subset of an available bandwidth for uplink and/or downlink operation. In various embodiments, the wireless device 50 may be configured to carry out either or both of the methods illustrated in FIGS. 7 and 8, for example.

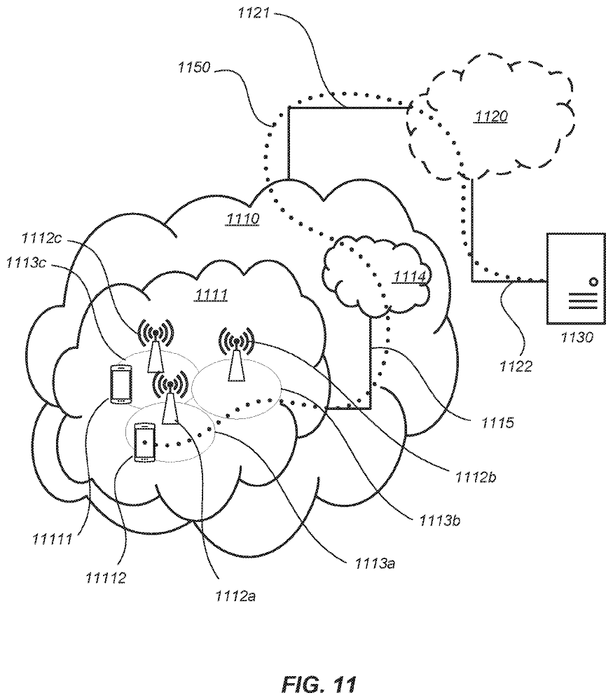

FIG. 11, according to some embodiments, illustrates a communication system that includes a telecommunication network 1110, such as a 3GPP-type cellular network, which comprises an access network 1111, such as a radio access network, and a core network 1114. The access network 1111 comprises a plurality of base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to the core network 1114 over a wired or wireless connection 1115. A first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112.

The telecommunication network 1110 is itself connected to a host computer 1130, which may be embodied in the hardware and/or software of a standalone server, a cloud-implemented server, a distributed server or as processing resources in a server farm. The host computer 1130 may be under the ownership or control of a service provider, or may be operated by the service provider or on behalf of the service provider. The connections 1121, 1122 between the telecommunication network 1110 and the host computer 1130 may extend directly from the core network 1114 to the host computer 1130 or may go via an optional intermediate network 1120. The intermediate network 1120 may be one of, or a combination of more than one of, a public, private or hosted network; the intermediate network 1120, if any, may be a backbone network or the Internet; in particular, the intermediate network 1120 may comprise two or more sub-networks (not shown).

The communication system of FIG. 11 as a whole enables connectivity between one of the connected UEs 1191, 1192 and the host computer 1130. The connectivity may be described as an over-the-top (OTT) connection 1150. The host computer 1130 and the connected UEs 1191, 1192 are configured to communicate data and/or signaling via the OTT connection 1150, using the access network 1111, the core network 1114, any intermediate network 1120 and possible further infrastructure (not shown) as intermediaries. The OTT connection 1150 may be transparent in the sense that the participating communication devices through which the OTT connection 1150 passes are unaware of routing of uplink and downlink communications. For example, a base station 1112 may not or need not be informed about the past routing of an incoming downlink communication with data originating from a host computer 1130 to be forwarded (e.g., handed over) to a connected UE 1191. Similarly, the base station 1112 need not be aware of the future routing of an outgoing uplink communication originating from the UE 1191 towards the host computer 1130.

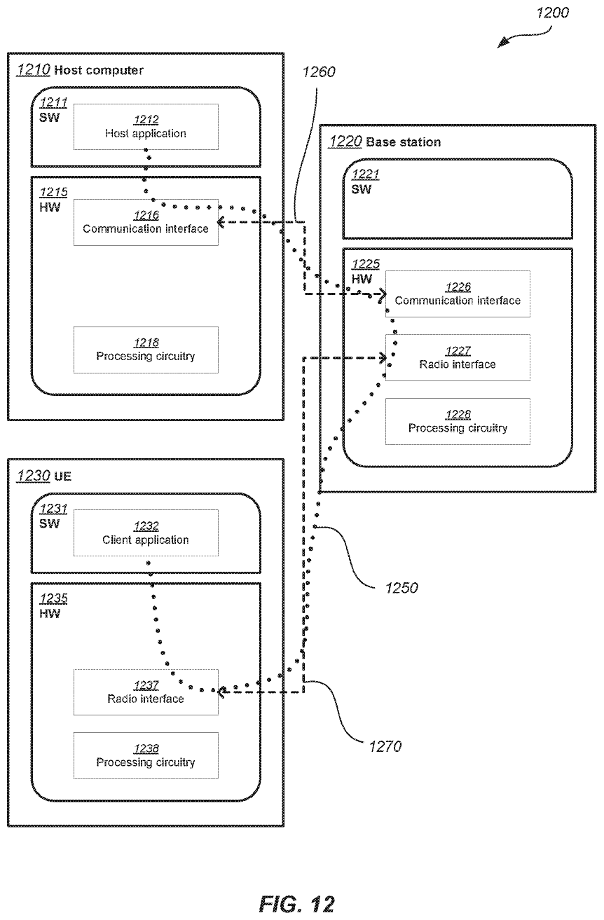

Example implementations, in accordance with an embodiment, of the UE, base station and host computer discussed in the preceding paragraphs will now be described with reference to FIG. 12. In a communication system 1200, a host computer 1210 comprises hardware 1215 including a communication interface 1216 configured to set up and maintain a wired or wireless connection with an interface of a different communication device of the communication system 1200. The host computer 1210 further comprises processing circuitry 1218, which may have storage and/or processing capabilities. In particular, the processing circuitry 1218 may comprise one or more programmable processors, application-specific integrated circuits, field programmable gate arrays or combinations of these (not shown) adapted to execute instructions. The host computer 1210 further comprises software 1211, which is stored in or accessible by the host computer 1210 and executable by the processing circuitry 1218. The software 1211 includes a host application 1212. The host application 1212 may be operable to provide a service to a remote user, such as a UE 1230 connecting via an OTT connection 1250 terminating at the UE 1230 and the host computer 1210. In providing the service to the remote user, the host application 1212 may provide user data which is transmitted using the OTT connection 1250.

The communication system 1200 further includes a base station 1220 provided in a telecommunication system and comprising hardware 1225 enabling it to communicate with the host computer 1210 and with the UE 1230. The hardware 1225 may include a communication interface 1226 for setting up and maintaining a wired or wireless connection with an interface of a different communication device of the communication system 1200, as well as a radio interface 1227 for setting up and maintaining at least a wireless connection 1270 with a UE 1230 located in a coverage area (not shown in FIG. 12) served by the base station 1220. The communication interface 1226 may be configured to facilitate a connection 1260 to the host computer 1210. The connection 1260 may be direct or it may pass through a core network (not shown in FIG. 12) of the telecommunication system and/or through one or more intermediate networks outside the telecommunication system. In the embodiment shown, the hardware 1225 of the base station 1220 further includes processing circuitry 1228, which may comprise one or more programmable processors, application-specific integrated circuits, field programmable gate arrays or combinations of these (not shown) adapted to execute instructions. The base station 1220 further has software 1221 stored internally or accessible via an external connection.

The communication system 1200 further includes the UE 1230 already referred to. Its hardware 1235 may include a radio interface 1237 configured to set up and maintain a wireless connection 1270 with a base station serving a coverage area in which the UE 1230 is currently located. The hardware 1235 of the UE 1230 further includes processing circuitry 1238, which may comprise one or more programmable processors, application-specific integrated circuits, field programmable gate arrays or combinations of these (not shown) adapted to execute instructions. The UE 1230 further comprises software 1231, which is stored in or accessible by the UE 1230 and executable by the processing circuitry 1238. The software 1231 includes a client application 1232. The client application 1232 may be operable to provide a service to a human or non-human user via the UE 1230, with the support of the host computer 1210. In the host computer 1210, an executing host application 1212 may communicate with the executing client application 1232 via the OTT connection 1250 terminating at the UE 1230 and the host computer 1210. In providing the service to the user, the client application 1232 may receive request data from the host application 1212 and provide user data in response to the request data. The OTT connection 1250 may transfer both the request data and the user data. The client application 1232 may interact with the user to generate the user data that it provides.

It is noted that the host computer 1210, base station 1220 and UE 1230 illustrated in FIG. 12 may be identical to the host computer 1130, one of the base stations 1112a, 1112b, 1112c and one of the UEs 1191, 1192 of FIG. 11, respectively. This is to say, the inner workings of these entities may be as shown in FIG. 12 and independently, the surrounding network topology may be that of FIG. 11.

In FIG. 12, the OTT connection 1250 has been drawn abstractly to illustrate the communication between the host computer 1210 and the use equipment 1230 via the base station 1220, without explicit reference to any intermediary devices and the precise routing of messages via these devices. Network infrastructure may determine the routing, which it may be configured to hide from the UE 1230 or from the service provider operating the host computer 1210, or both. While the OTT connection 1250 is active, the network infrastructure may further take decisions by which it dynamically changes the routing (e.g., on the basis of load balancing consideration or reconfiguration of the network).

The wireless connection 1270 between the UE 1230 and the base station 1220 is in accordance with the teachings of the embodiments described throughout this disclosure, such as provided by nodes such as wireless device 50 and network node 30. A problem addressed by the techniques described herein, which may be implemented in either or both of UE 1230 and base station 1220, is that previous methods for selecting and/or configuring BWPs for a UE do not always select the optimal BWP, and that methods for ensuring that a UE is configured with the best set of BWPs are also needed. The advantage of the embodiments is that the UE is more often provided with an optimal BW for its data throughput needs. This may improve data rate, latency and/or power consumption for the network and UE 1230 using the OTT connection 1250 and thereby provide benefits such as reduced user waiting time, better responsiveness, and better device battery time.

A measurement procedure may be provided for the purpose of monitoring data rate, latency and other factors on which the one or more embodiments improve. There may further be an optional network functionality for reconfiguring the OTT connection 1250 between the host computer 1210 and UE 1230, in response to variations in the measurement results. The measurement procedure and/or the network functionality for reconfiguring the OTT connection 1250 may be implemented in the software 1211 of the host computer 1210 or in the software 1231 of the UE 1230, or both. In embodiments, sensors (not shown) may be deployed in or in association with communication devices through which the OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of the OTT connection 1250 may include message format, retransmission settings, preferred routing etc.; the reconfiguring need not affect the base station 1220, and it may be unknown or imperceptible to the base station 1220. Such procedures and functionalities may be known and practiced in the art. In certain embodiments, measurements may involve proprietary UE signaling facilitating the host computer's 1210 measurements of throughput, propagation times, latency and the like. The measurements may be implemented in that the software 1211, 1231 causes messages to be transmitted, in particular empty or ‘dummy’ messages, using the OTT connection 1250 while it monitors propagation times, errors etc.

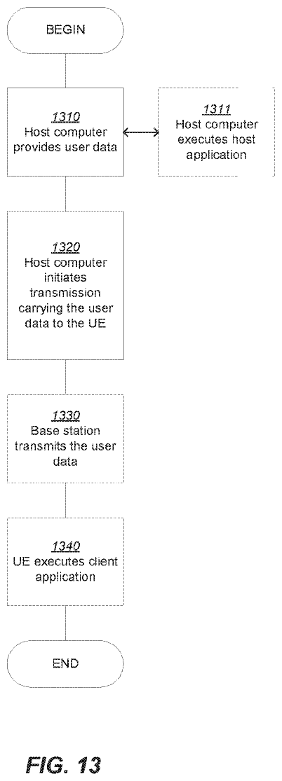

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In a first step 1310 of the method, the host computer provides user data. In an optional substep 1311 of the first step 1310, the host computer provides the user data by executing a host application. In a second step 1320, the host computer initiates a transmission carrying the user data to the UE. In an optional third step 1330, the base station transmits to the UE the user data which was carried in the transmission that the host computer initiated, in accordance with the teachings of the embodiments described throughout this disclosure. In an optional fourth step 1340, the UE executes a client application associated with the host application executed by the host computer.

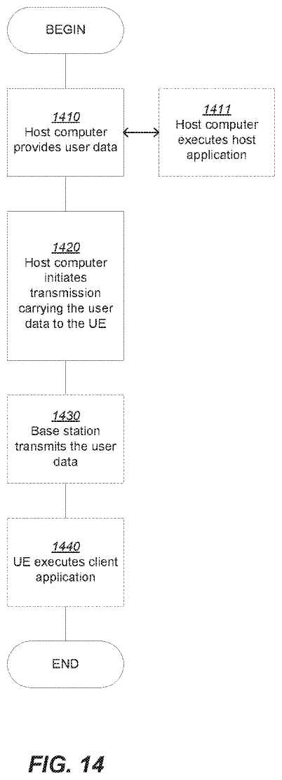

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In a first step 1410 of the method, the host computer provides user data. In an optional substep (not shown) the host computer provides the user data by executing a host application. In a second step 1420, the host computer initiates a transmission carrying the user data to the UE. The transmission may pass via the base station, in accordance with the teachings of the embodiments described throughout this disclosure. In an optional third step 1430, the UE receives the user data carried in the transmission.

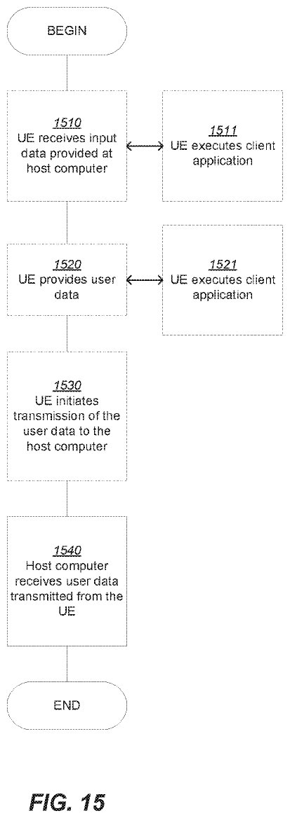

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In an optional first step 1510 of the method, the UE receives input data provided by the host computer. Additionally, or alternatively, in an optional second step 1520, the UE provides user data. In an optional substep 1521 of the second step 1520, the UE provides the user data by executing a client application. In a further optional substep 1511 of the first step 1510, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1530, transmission of the user data to the host computer. In a fourth step 1540 of the method, the host computer receives the user data transmitted from the UE, in accordance with the teachings of the embodiments described throughout this disclosure.

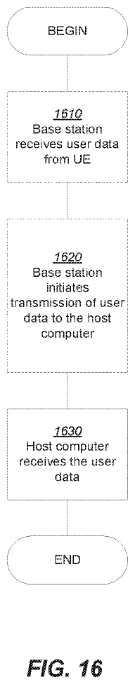

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In an optional first step 1610 of the method, in accordance with the teachings of the embodiments described throughout this disclosure, the base station receives user data from the UE. In an optional second step 1620, the base station initiates transmission of the received user data to the host computer. In a third step 1630, the host computer receives the user data carried in the transmission initiated by the base station.

According to some embodiments, a method implemented in a communication system including a host computer, a base station and a UE configured to selectively operate in one of two or more previously configured BWPs, each BWP being a different subset of an available bandwidth for uplink and/or downlink operation, comprises, at the host computer, providing user data and initiating a transmission carrying the user data to the UE via a cellular network comprising the base station.

As discussed in detail above, the techniques described herein, e.g., as illustrated in the process flow diagrams of FIGS. 7 and 8, may be implemented, in whole or in part, using computer program instructions executed by one or more processors. In some cases where multiple processors are involved, the functionality described herein may be split among several processors in distinct devices. It will be appreciated that a functional implementation of these techniques may be represented in terms of functional modules, where each functional module corresponds to a functional unit of software executing in an appropriate processor or to a functional digital hardware circuit, or some combination of both.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

### Abbreviations

### Abbreviation Explanation

UE User equipment
UL Uplink
DL Downlink
ML Machine learning
BWP Bandwidth part
SNR Signal to noise ratio
O-RAN Open Radio Access Network
RIC Radio intelligent controller

### REFERENCES

1. “3GPP TS38.211, v17.1.0,” [Online]. Available: https://www.3gpp.org/ftp/Specs/archive/38_series/38.211/38211-h10.zip.
2. “3GPP TS38.213, v17.1.0,” [Online]. Available: https://www.3gpp.org/ftp/Specs/archive/38_series/38.213/38213-h10.zip.
3. T.-H. Shih, et al., “Method and apparatus of selecting bandwidth part for random access (RA) procedure in a wireless communication system”. U.S. Pat. No. 10,701,734B2, 2018.
4. J. G. López-Puigcerver, “Design and optimization of Bandwidth Part selection for massive beamforming,” 2020. [Online]. Available: https://www.eit.lth.se/sprapport.php?uid=1318.
5. F. Abinader et al., “Impact of Bandwidth Part (BWP) Switching on 5G NR System Performance,” in IEEE 2nd 5G World Forum (5GWF), 2019.
6. X. Lin. D. Yu, and H. Wiemann, “A Primer on Bandwidth Parts in 5G New Radio,” [Online]. Available: https://arxiv.org/ftp/arxiv/papers/2004/2004.00761.pdf.
7. “O-RAN WG1.O-RAN Architecture Description,” [Online]. Available: https://www.o-ran.org/specification-access.
8. “O-RAN Working Group 3 Near-Real-time RAN Intelligent Controller Near-RT RIC Architecture (O-RAN WG3 RICARCH-v02.00),” [Online]. Available: https://www.o-ran.org/specification-access.
9. “O-RAN Reference Architecture,” [Online]. Available: http://www.techplayon.com/open-ran-o-ran-reference-architecture/.
10. 3GPP, “TS 38.401, v17.1.1,” [Online]. Available: https://www.3gpp.org/ftp/Specs/archive/38_series/38.401/38401-h11.zip.

1-20. (canceled)

21. A method for selecting a preferred active bandwidth part (BWP) for a user equipment (UE) in a wireless network supporting configurable BWPs, the method comprising:
estimating a desired bandwidth for the UE, using a trained machine-learning model operating on a plurality of measurements for the UE; and
selecting a preferred active BWP from a plurality of candidate BWPs, based on the estimated desired bandwidth.

22. The method of claim 21, wherein the method is carried out by the UE, and wherein the method further comprises signaling, to the wireless network, an indication of the selected preferred active BWP.

23. The method of claim 22, wherein the method further comprises receiving, in response to said signaling, an indication to change to the selected preferred active BWP.

24. The method of claim 21, wherein the method is carried out by a node in the wireless network, and wherein the method further comprises signaling, to the UE, an indication to change to the selected preferred active BWP.

25. The method of claim 21, wherein the plurality of measurements comprises any one or more of any of:
buffer status reports (BSRs);
power headroom reports (PHRs);
uplink and/or downlink data rates; and
uplink and/or downlink physical resource block (PRB) utilization.

26. The method of claim 21, wherein the trained machine-learning model further operates on any one or more of any of:
a minimum data rate;
a reliability requirement;
a latency requirement;
a preferred maximum bandwidth; and
a number of multiple-input-multiple-output (MIMO) layers.

27. The method of claim 21, wherein selecting the preferred active BWP comprises selecting the preferred active BWP according to one of the following selection strategies:
selecting a BWP having the lowest bandwidth, among the plurality of candidate BWPs, that is greater than the estimated desired bandwidth;
selecting a BWP having the highest bandwidth, among the plurality of candidate BWPs, that is lower than the estimated desired bandwidth; and
selecting a BWP having bandwidth closest to the estimated desired bandwidth, among the plurality of candidate BWPs.

28. The method of claim 21, wherein the trained machine-learning model has been trained using measurements for each of a plurality of UEs.

29. The method of claim 28, wherein the method comprises selecting the trained machine-learning model from a plurality of trained machine-learning models, according to a characteristic or classification of the UE, the selected trained machine-learning model having been trained using throughput-related measurements for a respective plurality of UEs having the same or similar characteristic or classification.

30. A method for configuring active bandwidth parts (BWPs) for a user equipment (UE) in a wireless network supporting configurable BWPs, the method comprising:
generating or receiving a feedback metric for a selected active BWP for the UE, the feedback metric being indicative of a distance of a bandwidth for the selected active BWP from an estimated desired bandwidth;
accumulating the feedback metric with a plurality of feedback metrics for the UE and/or one or more other UEs; and
determining whether to change a set of BWPs configured for the UE, based on the accumulated feedback metrics.

31. The method of claim 30, wherein said determining comprises determining to change the set of BWPs configured for the UE, and wherein the method further comprises signaling, to the UE, an indication of a change in the set of BWPs configured for the UE.

32. The method of claim 30, wherein the method is carried out by the UE and said determining comprises determining to change the set of BWPs configured for the UE, and wherein the method further comprises signaling, to the wireless network, an indication of a desired change in the set of BWPs configured for the UE.

33. The method of claim 30, wherein the plurality of measurements comprise any one or more of any of:
buffer status reports (BSRs);
power headroom reports (PHRs);
uplink and/or downlink data rates; and
uplink and/or downlink physical resource block (PRB) utilization.

34. The method of claim 30, wherein the trained machine-learning model further operates on any one or more of any of:
a minimum data rate;
a reliability requirement;
a latency requirement;
a preferred maximum bandwidth; and
a number of multiple-input-multiple-output (MIMO) layers.

35. The method of claim 30, wherein the trained machine-learning model has been trained using measurements for each of a plurality of UEs.

36. An apparatus configured to select a preferred active bandwidth part (BWP) for a user equipment (UE) in a wireless network supporting configurable BWPs, the apparatus comprising:
processing circuitry configured to:
estimate a desired bandwidth for the UE, using a trained machine-learning model operating on a plurality of measurements for the UE; and
select a preferred active BWP from a plurality of candidate BWPs, based on the estimated desired bandwidth.

37. The apparatus of claim 36, wherein the apparatus further comprises transceiver circuitry operatively coupled to the processing circuitry and configured to communicate with the wireless network, and wherein the apparatus is further configured to:
signal, to the wireless network, an indication of the selected preferred active BWP; and
receive, in response to said signaling, an indication to change to the selected preferred active BWP.

38. A network node configured to serve a wireless device configured to selectively operate in one of two or more previously configured bandwidth parts (BWPs), each BWP being a different subset of an available bandwidth for uplink and/or downlink operation, the network node comprising:
transceiver circuitry configured for communicating with the wireless device; and
processing circuitry operatively associated with the transceiver circuitry and configured to:
generate or receive a feedback metric for a selected active BWP for the wireless device, the feedback metric being indicative of a distance of a bandwidth for the preferred active BWP from an estimated desired bandwidth;
accumulate the feedback metric with a plurality of feedback metrics for the wireless device and/or one or more other wireless devices; and
determine whether to change a set of BWPs configured for the wireless device, based on the accumulated feedback metrics.

39. The network node of claim 38, wherein the apparatus is further configured to signal, to the UE, an indication to change to the selected preferred active BWP.
